(19) United States
(12) Patent Application Publication
(10) Pub. No.: US 2007/0001411 A1
(43) Pub. Date: Jan. 4, 2007

(54) Swivel and Stop-limit feature on wheelbarrows for automatic load adjustment

(75) Inventor: Guye Strobel, Winnipeg, Manitoba (CA)

Correspondence Address: STROBEL HOLDINGS, INC., 6343 SOUTH BOINE DRIVE, WINNIPEG, MB, R3R-0B7, CA

(73) Assignee: STROBEL HOLDINGS, Winnipeg, Manitoba (CA)

(21) Appl. No.: 11/160,606

(22) Filed: Jun. 30, 2005

(51) Int. Cl. B62B 1/00

(52) U.S. Cl. 280/47.31

(57) ABSTRACT

A swivel adaptation to wheelbarrows is presented for patent that allows the tray assembly to adjust to rolling terrain—independent of ground levelness. The swivel is combined with a limiting feature that prevents the tray from overturning under conditions of load shifting. This invention is of particular value when incorporated into wide wheel-based configurations such as those using multiple wheels.

### BACKGROUND

Wheelbarrows are an important tool used at home and work to support manual labor. The conventional barrow has a tray mounted on two handlebars (or undercarriages) that provide a supporting bridge between the wheel and the grips held by the operator. The conventional design, using one wheel, allows the barrow to pivot around the point defined by where the wheel meets the ground. In this conventional design, tilting of the terrain is not transferred to sidebars and tray, thereby eliminating torque transfer to the operator due to uneven terrain. However, under conditions of load shifting, full torque is applied to the grips thereby burdening the operator.

Recently, this conventional product has been widely marketed in a modified version whereby two wheels are placed where only one existed in the original design. The multiple wheels benefit the conventional design by making it more stable and less likely to tip sideways. This is achieved by creating two pivot points off the center axis of the load thereby applying torque against the tipping. Unfortunately for this modification, this also means that unevenness in the terrain is transferred to the grips—unevenly between each of them. This is awkward for the operator in only mildly undulating terrain, becoming very difficult and disconcerting as the terrain becomes more uneven. The operator must constantly adjust his/her posture or suffer the load being transferred to one arm or the other in an often drastic manner.

### SUMMARY OF THE INVENTION

This invention is the swivel design to allow the wheel assembly of a wheelbarrow to tilt with the terrain while the tray and handles remain level to the operator. This is coupled with stop-limits to prevent tipping in extreme cases of load shifting.

### DESCRIPTION OF THE INVENTION

This invention is a swivel point with stop-limits between the wheel assembly and the tray/handle assembly as on the conventional wheelbarrow. The swivel point allows the tray and handle to rotate independent of the wheel(s). The axis of rotation is closely horizontal with the ground. This axis also closely intersects the center of the wheel (vertically and horizontally) and the center of the axis defined by the line through both handle grips used by the operator. (The orientation of the axis is not strictly defined as part of this invention.)

In order to reestablish the stability offered by a wide wheelbase, that is lost due to the swivel feature, stop-limit points are implemented into the swivel mechanism. Up to the stop-limit, any torque introduced as the load shifts is transferred to either grip. However, beyond the stop-limit, torque is transferred directly to the wheel assembly thereby reestablishing the underlying stability advantage of the wider wheel-base design. This stop-limit could be graduated, designed to transfer more of the torque onto the wheels the further the tray rotates, or it could be fixed—100% on the operator up to the stop-limit then 100% on the wheel assembly beyond the stop-limit. These features combined, gives the barrow the freedom to adjust as offered by the single wheeled barrow with the stability offered by a wide wheelbase.

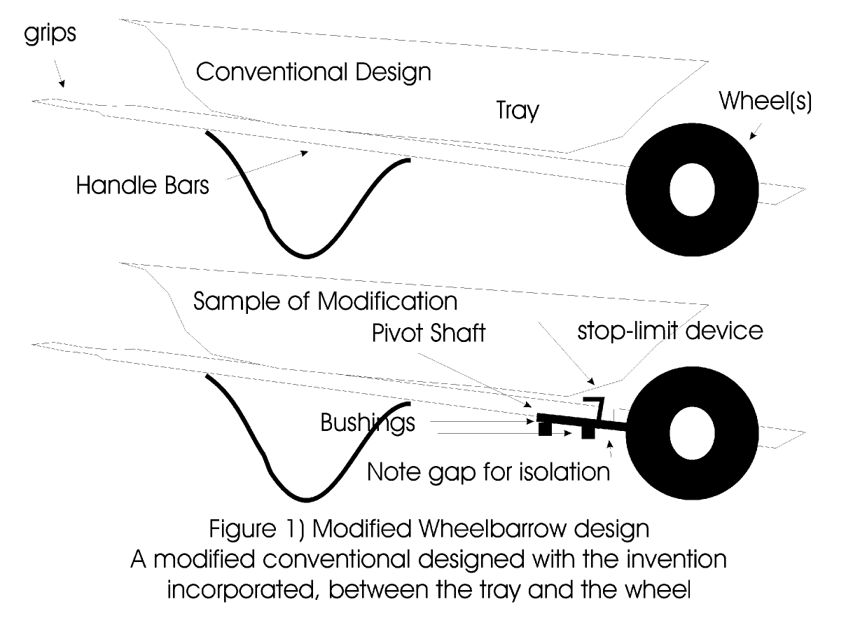

The conventional design need not be significantly modified to implement this invention. Existing wheelbarrows could be retrofitted with the invention as part of a harness unit comprising assembly braces, blocks, and swivel axel along with necessary components to make these elements work together. A gap in the undercarriage at the point of installation would be necessary. One such implementation is illustrated in FIG. 1).

Sequence Listing

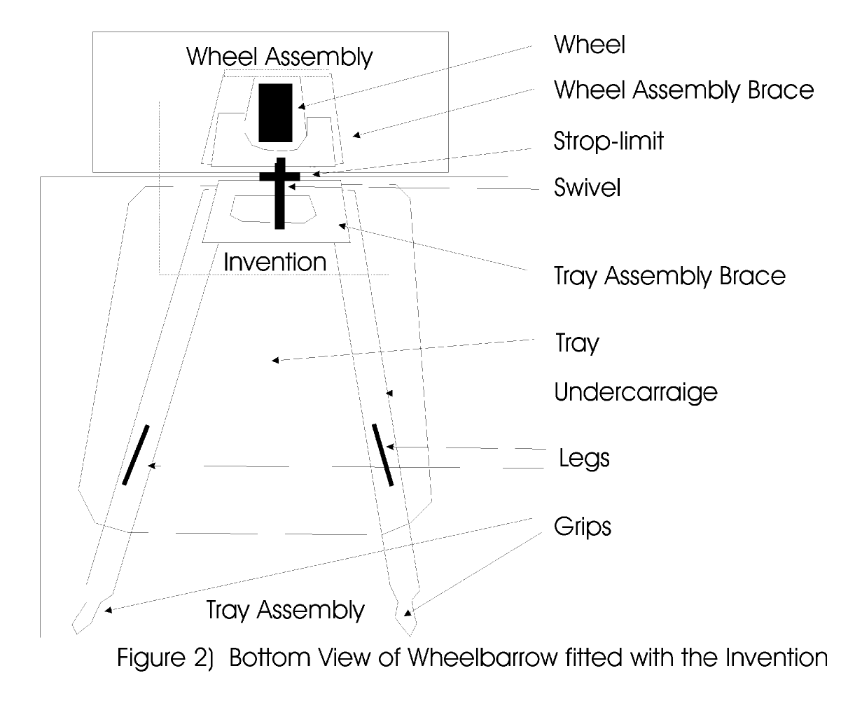

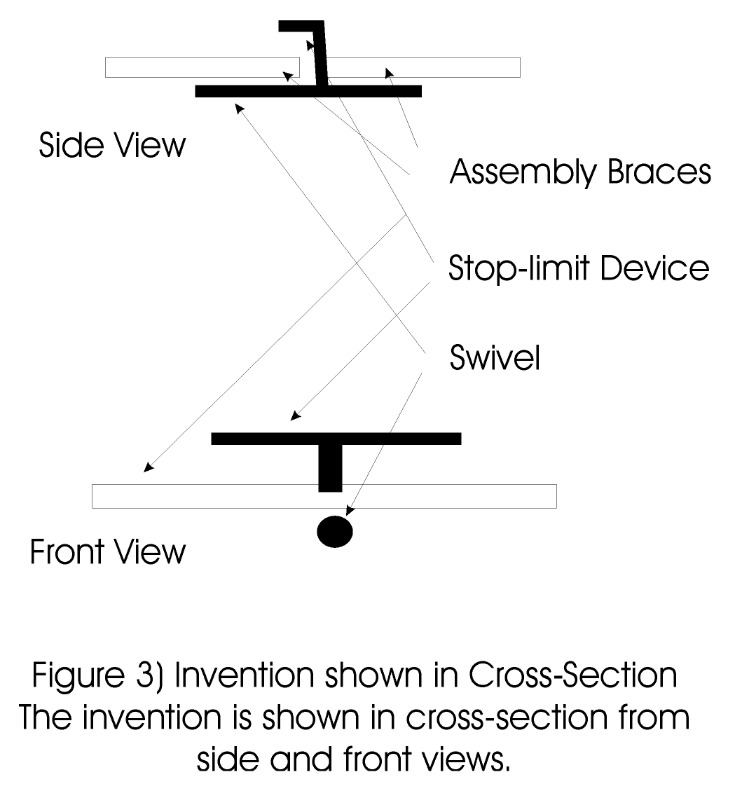

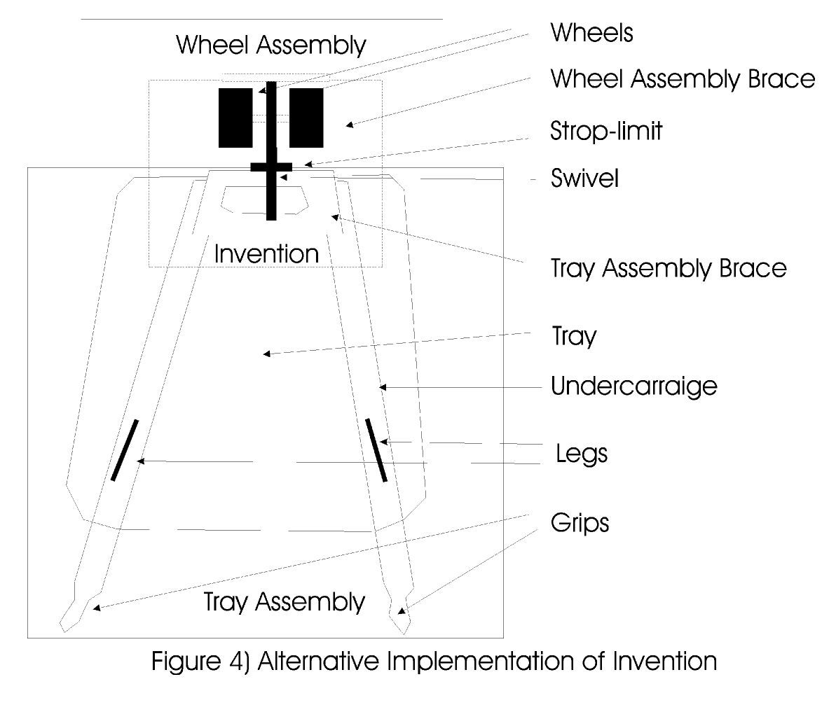

The sequence listing is as follows:
(1) In the new construction of a wheelbarrow that implements this invention, each supporting undercarriage comprises two pieces (whereas the conventional comprise one).
(2) In retrofitting an existing wheelbarrow, the undercarriage is cut at the tray and the wheel(s).
(3) The front section becomes the wheel assembly with wheel, front bumper, and short elements of the undercarriage (see FIG. 2). One element of the invention braces these pieces together, even, possibly, replacing this section of the undercarriage (wheel element brace)
(4) In new construction, the invention can be constructed as part of the wheel assembly (see FIG. 3).
(5) The front section becomes the tray assembly with grips, tray, supporting legs and remaining elements of the undercarriage. One element of the implementation braces these pieces together (tray element brace). Best candidate material for the brace elements is metal.
(6) A swivel attaches these two elements together. In the conceptual design shown, a metal bar serves this purpose (swivel).
(7) To prevent tipping, stop-limits (see FIG. 4) are implemented such that if the tray assembly over-rotates, the two assemblies lock and the complete wheelbarrow becomes rigid thereby allowing the wheel assembly to brace itself against further tipping.

What is claimed is:

1. The swivel mechanism elements that allow the rotation about the axis noted above.

2. The stop-limit mechanism. Limit points would exist for both rotations—counter clockwise and clockwise.
